(19) United States
(12) Patent Application Publication
(10) Pub. No.: US 2011/0154210 A1
(43) Pub. Date: Jun. 23, 2011

(54) MULTIPLE USER TERMINAL DEVICE WHICH MULTIPLE USERS WATCH SIMULTANEOUSLY, SERVER FOR MANAGING MULTIPLE USERS' USAGE OF CONENTS AND METHOD FOR MANAGING MULTIPLE USERS AND COTNENTS WHICH MULTIPLE USERS WATCH SIMULTANEOUSLY

(76) Inventor: Jung-Sik SUNG, Daejeon (KR)

(21) Appl. No.: 12/971,152

(22) Filed: Dec. 17, 2010

(30) Foreign Application Priority Data
Dec. 18, 2009 (KR) 10-2009-0126720
Mar. 30, 2010 (KR) 10-2010-0028664

(51) Int. Cl. G06F 15/177; H04L 9/32

(52) U.S. Cl. 715/736; 726/28

(57) ABSTRACT

Provided is a technology that efficiently manages a session and ensures the continuity of providing a service in a multiple user terminal device which multiple users watch simultaneously. An embodiment of the present invention provides a multiple user terminal device which multiple user watch simultaneously that comprises: user authenticator receiving user information of users in response to accesses of multiple users from a management server; a session controller generating a command of at least one of addition and removal of multiple users to and from a session corresponding to contents for usage of the contents on the basis of the user information; and a usage information manager acquiring contents usage information for each user when one of the multiple users terminates the access.

### CROSS REFERENCE TO RELATED APPLICATION

This application claims the benefit of Korean Patent Application No. 10-2009-0126720, filed on Dec. 18, 2009 and Korean Patent Application No. 10-2010-0028664, filed on Mar. 30, 2010, which are hereby incorporated by reference in its entirety into this application.

### BACKGROUND OF THE INVENTION

1. Field of the Invention

The present invention relates to a technology for managing multiple users' usage of contents using a single session. More particularly, the present invention relates to a technology that can add or remove a user to or from a session when multiple users watch terminal devices by using a single session simultaneously and ensure that each of the multiple users continuously use contents by managing information on multiple users' usage.

2. Description of the Related Art

In recent years, with the development of technologies relating to video contents, technologies for using contents have also been developed. In particular, a video media providing service industry using video streaming or video media storage technology such as an Internet lecture has actively progressed around educational circles, and the like.

In the existing video media providing service, users access contents servers by using their own Window-based terminals. In general, the contents sever is connected with the user terminal through a session one to one to provide the video media providing service. However, for example, in the case of a moving picture lecture of a school, a lot of costs are required to provide the moving picture lecture by using one terminal for one student. Therefore, in this case, an education through the moving picture lecture is performed by additionally providing a classroom for the moving picture lecture such as a computer lecture room, and the like.

In the existing video media providing service, one user generally watches contents streaming by connecting to one session. Therefore, when a plurality of users watch contents by using one terminal (i.e., a large-sized projection TV) at one location, the plurality of users are recognized as one user to receive the video media providing service.

As a result, in the case in which some of the plurality of users who watch the contents move or should stop using the contents for personal reasons, the existing video media providing service cannot continuously provide the service to the users when some users want to continuously watch the existing contents by using their own terminals or other terminals at the location to which they move.

Accordingly, a necessity of a method for providing management for each user and for continuity of the video media service to each of multiple users in a multiple user terminal device which a plurality of users watch through a single session simultaneously has increased.

### SUMMARY OF THE INVENTION

The present invention has been made in an effort to provide a multiple user terminal device which multiple users watch through a single session simultaneously, which is manageable for each user. Further, the present invention has been made in another effort to provide a management server that is connected with the multiple user terminal device to manage information on the multiple users and information of the session in real time. In addition, the present invention has been made in yet anther effort to provide a method for providing the continuity of a contents providing service to the multiple users through the multiple user terminal device and the management server.

An embodiment of the present invention provides a multiple user terminal device which multiple user watch simultaneously that comprises: user authenticator receiving user information of users in response to accesses of multiple users from a management server; a session controller generating a command of at least one of addition and removal of multiple users to and from a session corresponding to contents for usage of the contents on the basis of the user information; and a usage information manager acquiring contents usage information for each user when one of the multiple users terminates the access.

The contents usage information includes contents identification information and information of a usage stopping location of the contents of the user. The user information includes at least one of user identification information, information of an access time of the user, information whether the user accesses or not, information of a terminal used by the user, and contents usage information corresponding to the played contents.

The session controller generates a command to add the user while the user accesses when the contents are already played, that is, when a session corresponding to the contents is opened in the multiple user terminal device. Further, when a session corresponding to contents to be used does not exist, the session controller generates a command to open a new session which sets the accessing user as a representative user.

When the representative user terminates the access, the session controller also maintains a session by setting a first participation user of the session as a new representative user and when the participation user does not exist, the session controller generates a command to eliminate the session.

The contents usage information is information for providing the contents from the usage stopping location when a user corresponding to the contents usage information wants to use the contents again.

An embodiment of the present invention provides a server for managing multiple users' usage of contents that comprises: a user information provider providing user information of a user who accesses to the multiple user terminal device in accordance with a request from the multiple user terminal device playing contents for multiple users; a session manager managing a session corresponding to the contents on the basis of the fact whether the multiple users access or not; and a user information manager updating the user information including contents usage information for each user when one of the multiple users terminates the access.

An exemplary embodiment of the present invention provides a A method for managing multiple users and contents which the multiple users watch simultaneously that comprising: receiving user information of users in response to the accesses of the multiple users from a management server by a user authenticator; generating a command of at least one of addition or removal of the multiple users to and from a session corresponding to contents for usage of the contents on the basis of the user information by a session controller; and acquiring contents usage information for each user when one of the multiple users terminates the access by a usage information manager.

According to the embodiments of the present invention, in a multiple user terminal device which multiple users watch using a single session simultaneously, since the usage of contents is managed for each user depending on user information, it is possible to manage the session for each user. As a result, even though some users among the multiple users terminate access, it is not difficult for other multiple users to use the contents. In addition, since a location where the user stops using the contents is stored in contents usage information, the user who terminates the access can continuously use the contents at the time of accessing the contents by using another terminal, thereby extending a contents usage range and in addition, improving the usage efficiency.

### BRIEF DESCRIPTION OF THE DRAWINGS

FIG. 1 is a block diagram of a multiple user terminal device which multiple users watch simultaneously according to an embodiment of the present invention;

FIG. 2 is a block diagram of a server for managing multiple users' usage of contents according to an embodiment of the present invention;

FIG. 3 schematically illustrates a contents usage pattern according to an embodiment of the present invention;

FIG. 4 illustrates a configuration example of user information according to an embodiment of the present invention;

FIG. 5 schematically illustrates a session management pattern of a session controller; and

FIGS. 6 and 7 are flowcharts of a method for managing multiple users and contents which the multiple users watch simultaneously according to an embodiment of the present invention.

### DETAILED DESCRIPTION OF THE PREFERRED EMBODIMENTS

Hereinafter, a multiple user terminal device which multiple users watch simultaneously, a server for managing multiple users' usage of contents, and a method for managing multiple users and contents which the multiple users watch simultaneously according to the embodiments of the present invention will be described with reference to the accompanying drawings.

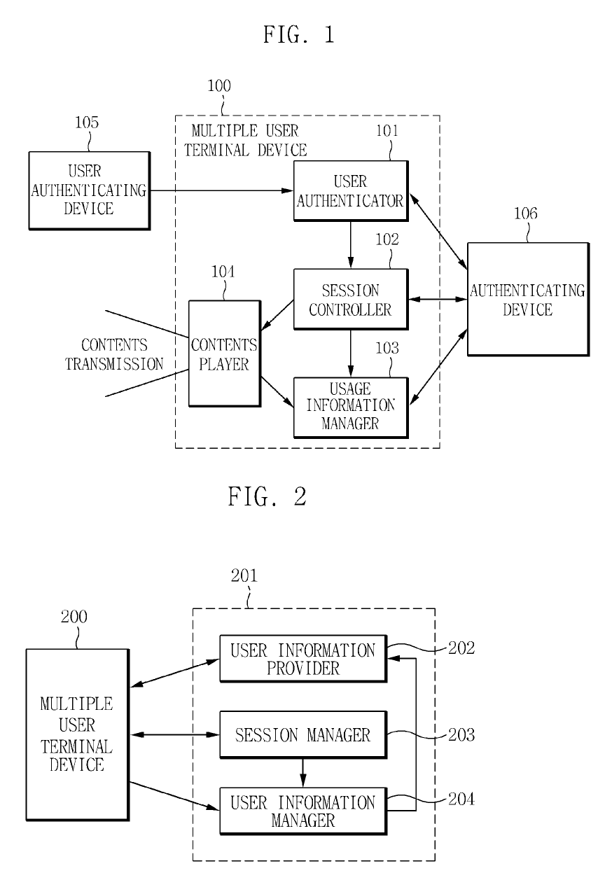

FIG. 1 is a block diagram of a multiple user terminal device which multiple users watch simultaneously according to an embodiment of the present invention.

Referring to FIG. 1, the multiple user terminal device 100 which multiple users watch simultaneously according to the embodiment of the present invention includes a user authenticator 101, a session controller 102, and a usage information manager 103.

The multiple user terminal device 100 may further comprise a contents player 104. Further, user authenticating devices 105 of users may be connected to the user authenticator 101. The multiple user terminal device 100 is connected with a server for managing multiple users' usage of contents (hereinafter, referred to as a “management server”) 106 to provide a service to the multiple users.

The user authenticator 101 receives user information of users who accesses in response to accesses of the multiple users from the management server 106.

The user attempts the access to the multiple user terminal device 100 in order to use the contents. The user authenticator 101 requests user information of the user who attempts access to the multiple user terminal device 100 in response to the user's access to the multiple user terminal device 100. Therefore, the user authenticator 101 authenticates whether or not the corresponding user is an authenticated user as well as acquiring the user information.

The user authenticating device 105 may be provided as a device which the user uses to access the user authenticator 101. The user authenticating device 105 may be all devices that can identify the user so as for the user authenticator 101 to request correct user information to the management server 106.

The user authenticating device 105 may be, for example, a device including a remote controller which is portable for each user. The user will be able to notify the user's access to the user authenticator 101 by doing actions such as pressing a log-in button of the remote controller, and the like in a space where the user can use the multiple user terminal device. Further, the user will be able to request the termination of the access from the multiple user terminal device 100 by pressing a log-out button of the remote controller.

When the user authenticating device 105 is the remote controller, the user may actively and interactively use contents with the multiple user authenticating device by using buttons installed in the remote controller. For example, the user may use an education system by using texts and numerical figures input.

The user authenticating device 105 may further include a magnetic card.

The user authenticating device 105 will be able to request the user's access and the termination of the user's access to the user authenticator 101 by recognizing the magnetic card.

The user authenticating device 105 may communicate with the user authenticator 101 through a wireless LAN, Bluetooth, Zigbee, or infrared communication, a card reader, or the like. A user identification key for identifying the user information may be stored in the user authenticating device 105.

The user authenticator 101 receives user identification information from the user authenticating device 105 in addition to the access request and transmits the user identification information to the management server 106. Thereafter, the user authenticator 101 receives the user information retrieved by the management server 106 in accordance with the user identification information.

The user identification information may be included in the user information in the embodiment of the present invention. The user identification information represents information for identifying the user in the management server 106 through the user authenticating device 105. For example, the user identification information may be the serial number of the user authenticating device 105. Further, a user ID stored in the user authenticating device 105 may be the user identification information.

A user's access time may be included in the user information. A time when the user recently accesses the management server 106 to use the contents may be stored in the user information. Further, information whether or not the user accesses the management server 106 may be included in the user information. When the user succeeds in accessing the management server 106 through the user authenticating device 105 and the user authenticator 101, information that the user accesses the management server 106 is presented to display that the user is using the contents at present.

Information on a user's personal terminal used by the user may be included in the user information. Since the user may use the contents through the multiple user terminal device 100 and the user's personal terminal, the user will be able to independently access the management server 106 by using the authenticated personal terminal. Accordingly, the information on the personal terminal which is accessible to the management server 106 will be able to be stored.

Contents usage information corresponding to contents reproduced by the user may be included in the user information. The contents usage information means a history of contents which the user uses up to now.

Therefore, the contents usage information may include information for identifying the contents, i.e., a contents name, a contents type, a contents file name, and an address where a contents file is located. Further, in order to ensure the continuity of the usage of the contents, information which may indicate that the usage of the contents is stopped in the middle at the time of using the contents for each user is required.

For this, the contents usage information may include a user's contents usage stopping location and contents identification information. The contents usage stopping location may include information on a time or a scene at which the user stops the recent usage of the contents for each of the contents.

The session controller 102 generates a command of any one of addition and removal of the user to and from a session corresponding to the contents so as for the multiple users to use the contents on the basis of the user information.

The session controller 102 substantially manages the multiple users' accesses to the multiple user terminal device 100. When the user authenticator 101 receives the user information from the management server 106, the session controller 102 receives the user information from the user authenticator 101, and manages the addition and removal of the user information to and from the session depending on the user information.

It is assumed that the contents are used through the multiple user terminal device 100. The state in which the contents are used means that the multiple users already access and watch the contents. In this case, when one user attempts the access to the user authenticator 101 through the user authenticating device 105, the user authenticator 101 receives the user information from the management server 106 and transmits the user information to the session controller 102.

The session controller 102 analyzes whether or not a history using contents presently used by the user exists by analyzing the contents usage information included in the received user information. When the presently used contents exist in the user's contents usage information, the session controller 102 may control the user to select using the contents from the contents usage stopping location by analyzing the contents usage stopping location or using the contents from the present contents usage time. Alternately, the user may use the multiple user terminal device 100, but the session controller 102 may deny the addition of contents which cannot be used to the session in accordance with the user identification information.

The session controller 102 may generate a command to add a user corresponding to the user identification information to the session, to the management server 106 by using the user identification information. Further, the session controller 102 may generate a command to continuously update the user access time included in the user information at the time of adding the user to the session in the management server 106.

Further, when the user stops using the contents, the session controller 102 will be able to transmit a command to remove the user who stops using the contents from the session, to the management server 106.

That is, the session controller generates a command to add the accessing user to the session when the contents are already played in the session. On the contrary, when a session corresponding to the contents does not exist, that is, when the contents are not played by the multiple user terminal device, the session controller may generate a command to open a new session using the accessing user as a representative user.

The session corresponding to the contents used in the multiple user terminal device is opened by using a first accessing user among the multiple users as the representative user. Thereafter, accessing users as participation users are recognized as users who merely participate in the session to manage the session.

Therefore, when the participation user other than the representative user terminates the access and as a result, should be removed from the session, the session controller 102 generates a command to remove user information corresponding to the removal target participation user from the session.

If the user who terminates the access is the representative user, the session controller 102 generates a command to remove user information corresponding to the representative user which is the removal target from the session. In addition, the session controller 102 generates a command to set a user who participates in the session earliest among the participation users, that is, the first participation user as a new representative user of the session. Therefore, even though the representative user who newly opens the session terminates the access, the session may be normally maintained and as a result, the multiple user terminal device 100 which the multiple users watch simultaneously will be able to perform a normal function regardless of the user's access or not.

When the representative user terminates the access, in the case in which there is no participation user, that is, in the case in which the number of users is 1, the session controller 102 will be able to, of course, generate the command to remove the session.

The session controller 102 may transmit the contents provided from the management server 106, to the contents player 104 so as to play the contents through the session managed by the management server 106.

The usage information manager 103 acquires the contents usage information for each user when any one of the multiple users terminates the access. The contents usage information acquired by the usage information manager 103 is transmitted to and managed by the management server 106.

The usage information manager 103 acquires the contents identification information and the information on the location where the user stops using the contents from the contents player 104 when the user terminates the access.

The information acquired by the usage information manager 103 is thereafter managed by the management server 106. Therefore, when the user who terminates the access uses the contents by accessing the management server 106 by using not the multiple user terminal device 100 but another terminal (i.e., a personal terminal device), the corresponding user may continuously use the contents on the basis of the contents usage information.

For example, when user a stops using the contents and terminates the access at a time of 12 minutes after 34 seconds while using contents C1 in the multiple user terminal device 100, the session controller 102 notifies the termination of the user a′s access to the contents player 104. The usage information manager 103 acquires identification information of contents C1 and a contents usage stopping location of 12 minutes after 34 seconds from the contents player 104. The management server 106 manages the contents usage information transmitted by the usage information manager 103.

Thereafter, when user a individually accesses the management server 106 to use contents C1 through not the multiple user terminal device 100 but the personal terminal device, user a may continuously use the contents from the contents usage stopping location on the basis of the contents usage information without playing the first part of contents C1.

Accordingly, the contents usage information serves as information for providing the contents from the usage stopping location when a user corresponding to the contents usage information wants to use the contents again.

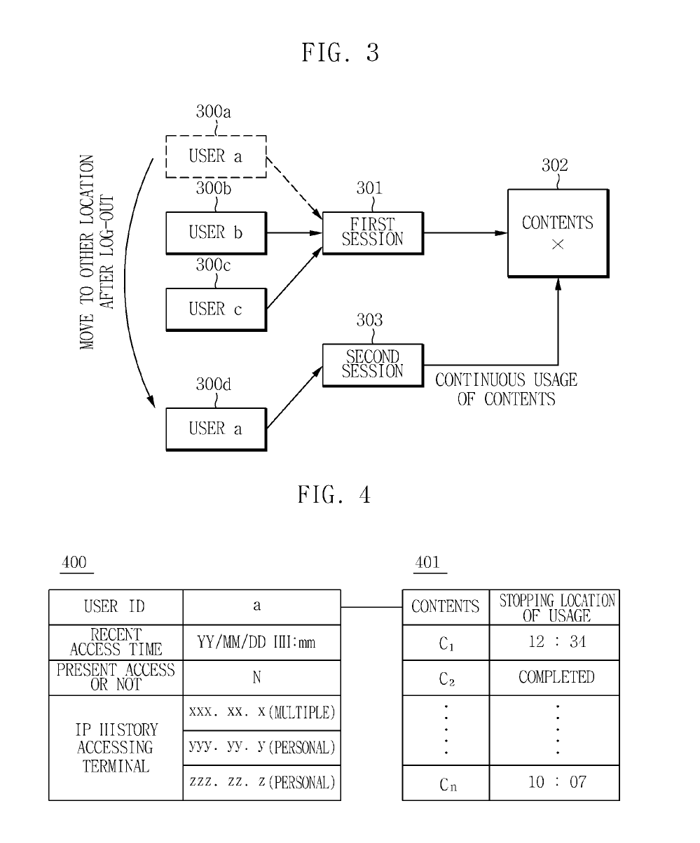

FIG. 2 is a block diagram of a server 201 for managing multiple users' usage of contents according to an exemplary embodiment of the present invention.

Referring to FIG. 2, the multiple user contents usage management server 201 according to the exemplary embodiment of the present invention includes a user information provider 202, a session manager 203, and a user information manager 204. Hereinafter, duplicate parts with those of FIG. 1 will not be described.

The user information provider 202 provides user information of a user who accesses the multiple user terminal device to the multiple user terminal device in accordance with a request from the multiple user terminal device that plays contents for the multiple users.

The user information provider 202 receives the user identification information from the user authenticator of the multiple user terminal device. The user information provider 202 retrieves user information corresponding to a user who requests the access on the basis of the user identification information in the user information manager 204 that manages the user information. When the user information is retrieved, the user information provider 202 transmits the user information to the user authenticator.

The session manager 203 manages a session corresponding to the contents on the basis of multiple users' accesses or not. The session manager 203 substantially manages the session by performing a function corresponding to a command of the session controller of the multiple user terminal device.

Accordingly, the session manager 203 receives the user information and the command for the session control from the session controller 102. Further, the session manager 203 converts the session to a database to perform generation, management, and removal functions. In addition, the session manager 203 provides contents to be used to the contents player through the session controller by corresponding the corresponding contents to the sessions, respectively. Therefore, the session manager 203 may further be connected to an external server storing contents and may further correspond the contents to each session.

The session manager 203 may add or remove user identification information of a user who uses the contents to or from the session corresponding to the used contents. The session controller 102 of FIG. 1 substantially performs the generation command.

The usage information manager 204 updates and manages, in real time, the user information including the contents usage information for each user when any one of the multiple users terminates the access.

The user information manager 204 receives information on an access termination time when the user terminates the access, from the session manager 203. Thereafter, the user information manager 204 updates the access time information included in the user information. In addition, the user information manager 204 also updates information on the user's access or not.

Further, the user information manager 204 receives the contents usage information for each user from the usage information manager, the user information manager 204 updates and manages the contents usage information corresponding to the contents played by the user, which is included in the user information.

Besides, when the personal terminal information needs to be updated for each user, the user information manager 204 updates the personal terminal information to allow the user to efficiently use the contents by using a plurality of terminals.

FIG. 3 schematically illustrates a contents usage pattern according to an exemplary embodiment of the present invention. Hereinafter, duplicate parts with those of FIGS. 1 and 2 will not be described.

Referring to FIG. 3, a first session 301 is opened in the management server in order to play contents X 302. A representative user for the first session 301 is set as user a 300a. User b 300b and user c 300c is first and second participation users in the first session 301 opened by user a 300a's access to contents X 302.

The first session 301 thus represents a session set in the multiple user terminal device. In the multiple user terminal device, users a, b, and c 300a 300b, and 300c are using contents X 302 through the first session 301. In this case, user a 300a which is the representative user of the first session 301 terminates the access to the first session 301 set in the multiple user terminal device through log-out. In this case, a new representative user of the first session 301 is set as user b 300b which is the first participation user to maintain the first session 301. Therefore, users b and c 300b and 300c may use the first session 301 as it is regardless of the access termination of the user a 300a or not.

User a 300a who terminates the access to the first session 301 moves to a location and wants to continuously contents X 302 by using the personal terminal. In this case, a second session 303 corresponding to the personal terminal is opened. In addition, the moving user a 300d may use contents X 302.

In this case, the user information manager of the management server acquires contents usage stopping location information of user a 300d for contents X 302 by analyzing the contents usage information included in the user information. User a 300d may receive contents X 302 from the usage stopping location at the time of using contents X 302 on the basis of the contents usage stopping location information to ensure continuity at the time of using the contents.

FIG. 4 illustrates a configuration example of user information according to an exemplary embodiment of the present invention. Hereinafter, duplicate parts with those of FIGS. 1 to 3 will not be described.

Referring to FIG. 4, the user information includes contents usage information 401 and other user information 400. The user information is managed by the user information manager of the management server. The user information is updated by the session controller, the usage information manager, and the session manager of the manager server of the multiple user terminal device.

The contents usage information 401 may include contents identification information C1 to Cn and the contents usage stopping location. Other user information 400 will be able to include all information other than the contents usage information 401 included in the user information described in the description of FIG. 1. For example, user identification information (user ID), an access time (recent access time), access or not (current access or not), and user's usage terminal information (access terminal IP history) may be included in other user information 400.

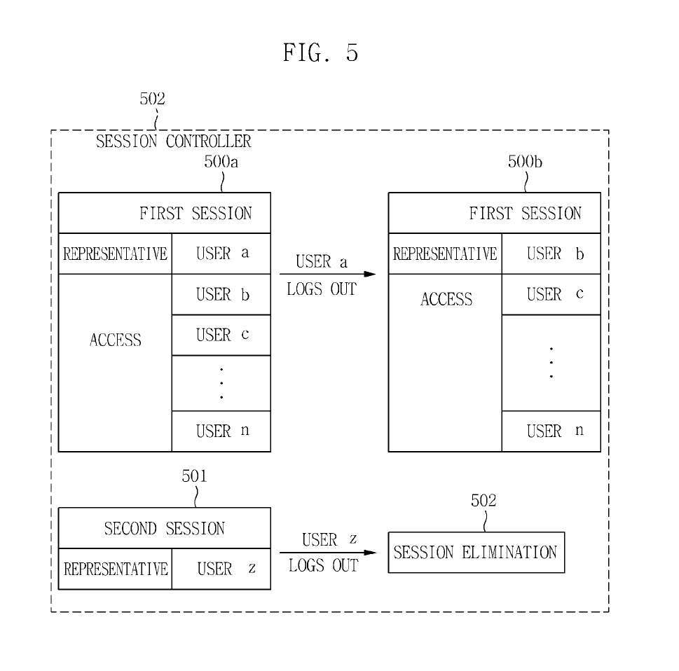

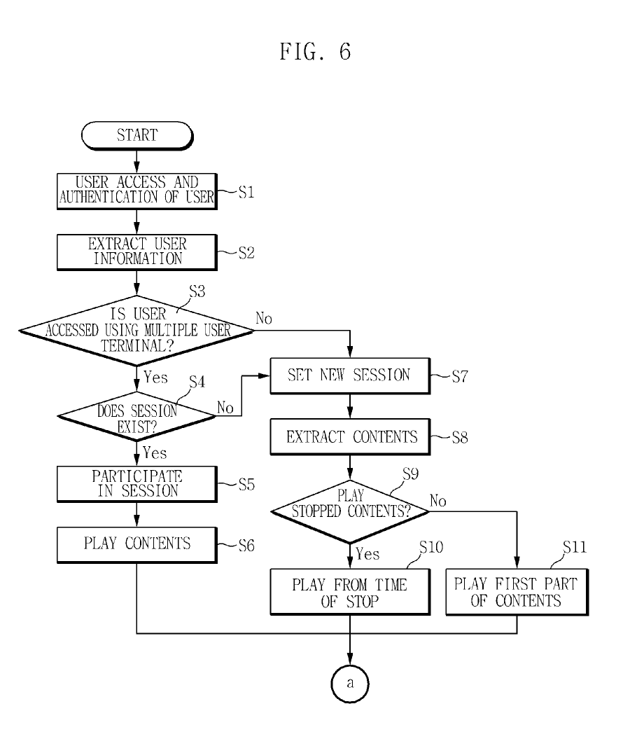

FIG. 5 schematically illustrates a session management pattern of a session controller. Hereinafter, duplicate parts with those of FIGS. 1 to 4 will not be described.

Referring to FIG. 5, the session controller 502 generates a command to control a session managed by the session manager of the management server. An example shown in FIG. 5 illustrates a session management pattern depending on the command generated by the session controller 502. A configuration that substantially manages the session is the session manager of the management server.

A first session 500a and a second session 501 are managed by the session manager. The session controller 502 generates a control command for the first session 500a and the second session 501. First, a representative user of the first session 500a is a and users who access as participation users are b to n.

When user a terminates the access to the first session 500a through log-out, the session controller generates a command to remove user a from the first session 500a. Since user a is the representative user, the session controller 502 determines whether or not the participation user exists in the first session 500a. Participation users b to n exist in the first session 500a and among them, user b is set as a user who participates earliest. Therefore, the session controller 502 generates a command to set user b as a new representative user of an updated first session 500b.

In the case of the second session 501, user z is set as the representative user. Like the examples in the first sessions 500a and 500b, user z terminates the access through log-out. In this case, the session controller 502 determines whether or not the user who participates in the second session 501 exists. No participation user exists in the second session 501. In this case, the session controller 502 generates a command to remove the second session 501.

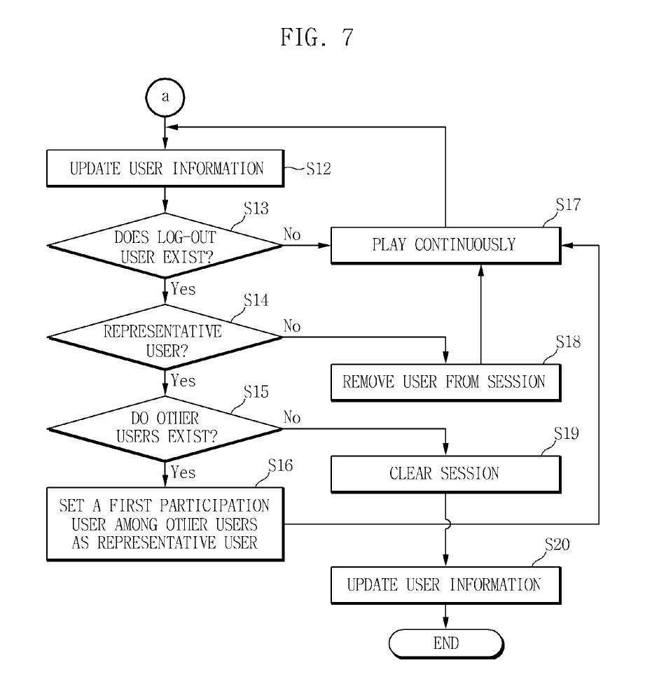

FIGS. 6 and 7 are flowcharts of a method for managing multiple users and contents which the multiple users watch simultaneously according to an exemplary embodiment of the present invention. Hereinafter, duplicate parts with those of FIGS. 1 to 5 will not be described.

First, the multiple users attempt the user access of the user authenticator through the user authenticating device and transmits the user identification information (S1). The user authenticator authenticates the user on the basis of the identification information for each user and receives the user information from the user information provider on the basis of the identification information for each user (S2). Steps S1 and S2 may also be performed between the persona terminal and the user information provider of the management server at the time of accessing the management server by using the personal terminal.

Thereafter, whether the management server is accessed by the personal terminal or accessed by the user authenticator of the multiple user terminal device may be determined (S3). However, in the exemplary embodiments of the present invention described in FIGS. 1 to 5, since the user information is transmitted through the user authenticator, it is assumed that the user information is accessed through the multiple user terminal device. Therefore, in this case, step S3 may be omitted.

In the case in which the accesses using the multiple user terminal, the session controller determines whether the contents which the accessing user will use are already played by other multiple users in the multiple user terminal device, that is, the session corresponding to the contents already exists (S4).

When the session exists, the session controller generates a command to add the user information to the session so that the accessing user participates in the session and transmits the generated command to the session manager (S5). Thereafter, the contents player continuously plays the contents (S6) to allow the user to use the contents.

The contents which the accessing user will use may not be played in the multiple user terminal device, that is, the session corresponding to the contents may not exist. Alternately, the access may be performed through the personal terminal. In the above-mentioned two cases, the session controller generates a command to set a new session corresponding to the contents to be used (S7). Thereafter, the session controller analyzes the contents usage information among the user information received by the user authenticator through the user information manager and the user information provider. The session controller analyzes the contents usage information to analyze whether the corresponding contents usage information is play stopped contents where a play stopped location exists (S9).

When the contents usage stopping location exists in the contents usage information, the contents are provided to be played from the play stopped location (S10) and when the contents usage stopping location does not exist, the first part of the contents are provided to be played (S11). Therefore, the continuity of the service is ensured. Of course, it is natural that a menu for allowing the user to select steps S10 and S11 may be provided.

The session controller and the session manager continuously update the user information including the access time, i.e., a recent access termination time during the user's access (S12). In addition, whether or not a user who performs log-out exists, that is, whether or not a user who terminates the access exists is also determined (S13). When the user who terminates the access is discovered, whether the user who terminates the access is the representative user is determined (S14).

If the user who terminates the access is not the representative user, the session controller generates a command to remove the user who terminates the access from the session including the user (S18). If the user who terminates the access is the representative user, the session controller determines whether another user, that is, the participation user exists (S15).

The session controller generates a command to remove (alternately cancel) the session when another user does not exist (S19). In addition, the user information managed by the user information manager is updated through the usage information manager (S20). When another user exists, the best participation user among other users, that is, a user who participates in the session earliest is set as the new representative user (S16) and thereafter, the contents are used (S17). Information on a user who is removed from the session, that is, who terminates the access is updated (S12).

The description of FIGS. 6 and 7 will be described in accordance with the configuration of the present invention described in FIGS. 1 to 5.

First, the user authenticator receives user information on a user who accesses in response to multiple users' accesses from the user information provider of the management server (S1 and S2). Thereafter, the session controller generates a command for at least one of addition and removal of the user information to a session corresponding to contents for multiple users' usage of contents on the basis of the user information (S4, S5, S7, S13, S14, S15, S16, S17, S18, and S19). In addition, the usage information manager acquires the contents usage information for each user when one of the multiple users terminate the access and a user information updater updates the user information on the basis of the acquired contents usage information for each user (S20 and S12).

The session manager of the management server substantially performs the command of the session controller.

Hereinafter, the description of the multiple user terminal device which multiple users watch simultaneously, the server for managing multiple users' usage of contents, and the method for managing multiple users and contents which the multiple users watch simultaneously according to exemplary embodiments of the present invention will not limit the appended claims. Further, except for the exemplary embodiment of the present invention, it will be apparent that an equivalent invention having the same function as the present invention will also be included in the scope of the present invention.

What is claimed is:

1. A multiple user terminal device which multiple users watch simultaneously, comprising:
a user authenticator receiving user information of users in response to accesses of multiple users from a management server;
a session controller generating a command of at least one of addition and removal of the multiple users to and from a session corresponding to contents for usage of the contents on the basis of the user information; and
a usage information manager acquiring contents usage information for each user when one of the multiple users terminates the access.

2. The device of claim 1, wherein the contents usage information includes at least one of contents identification information and information of a usage stopping location of the contents of the user.

3. The device of claim 1, wherein the user information includes at least one of identification information of the user, information of an access time of the user, information whether the user accesses or not, information of a terminal used by the user, and contents usage information corresponding to contents played by the user.

4. The device of claim 1, wherein the session controller generates a command to add the user to the session when the contents are already played.

5. The device of claim 1, wherein the session controller generates a command to open a new session which sets the user as a representative user when the session corresponding to the contents does not exist.

6. The device of claim 1, wherein the session controller generates a command to set a first participation user of the session as a new representative user of the session when a representative user terminates the access.

7. The device of claim 1, wherein the session controller generates a command to eliminate the session if a participation user of the session does not exist when a representative user terminates the access.

8. The device of claim 2, wherein the contents usage information is information for providing the contents from the usage stopping location when a user corresponding to the contents usage information wants to use the contents again.

9. A server for managing multiple users' usage of contents, comprising:
a user information provider providing user information of a user who accesses to the multiple user terminal device in accordance with a request from the multiple user terminal device playing contents for multiple users;
a session manager managing a session corresponding to the contents on the basis of the fact whether the multiple users accessor not; and
a user information manager updating the user information including contents usage information for each user when one of the multiple users terminates the access.

10. The server of claim 9, wherein the user information includes at least one of identification information of the user, information of an access time of the user, information whether the user accesses or not, information of a terminal used by the user, and contents usage information of the user.

11. The server of claim 9, wherein the contents usage information is information to provide the contents from the usage stopping location when a user corresponding to the contents usage information wants to use the contents again.

12. A method for managing multiple users and contents which the multiple users watch simultaneously, comprising:
receiving user information of users in response to the accesses of the multiple users from a management server by a user authenticator;
generating a command of at least one of addition or removal of the multiple users to and from a session corresponding to contents for usage of the contents on the basis of the user information by a session controller; and
acquiring contents usage information for each user when one of the multiple users terminates the access by a usage information manager.

13. The method of claim 12, further comprising updating the user information on the basis of the contents usage information for each user by a user information manager.

14. The method of claim 12, wherein the content usage information includes at least one of contents identification information and information of a usage stopping location of the contents.

15. The method of claim 12, wherein the contents usage information is information for providing the contents from the usage stopping location when a user corresponding to the contents usage information wants to use the contents again.

16. The method of claim 12, wherein the user information includes at least one of identification information of the user, information of an access time of the user, information whether the user accesses or not, information of a terminal used by the user, and contents usage information corresponding to contents played by the user.

17. The method of claim 12, wherein the generating of the command generates a command to add the user to the session when the contents are already played.

18. The method of claim 12, wherein the generating of the command generates a command to open a new session which sets the user as a representative user when the session corresponding to the contents does not exist.

19. The method of claim 12, wherein the generating of the command generates a command to set a first participation user of the session as a new representative user of the session when a representative user terminates the access.

20. The method of claim 12, wherein the generating of the command generates a command to eliminate the session if a participation user of the session does not exist when a representative user terminates the access.
